(19) United States
(12) Patent Application Publication
(10) Pub. No.: US 2026/0042378 A1
(43) Pub. Date: Feb. 12, 2026

(54) STATE OF CHARGE-BASED VEHICULAR MICRO CLOUD TASK SCHEDULING

(71) Applicant: Toyota Motor Engineering & Manufacturing North America, Inc., Plano, TX (US)

(72) Inventors: Seyhan Ucar, Mountain View, CA (US); Chunghan Lee, Mountain View, CA (US); Emrah Akin Sisbot, Menlo Park, CA (US); Onur Altintas, Sunnyvale, CA (US); Kentaro Oguchi, Mountain View, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/797,849

(22) Filed: Aug. 8, 2024

(51) Int. Cl. B60L 58/13; H04W 4/46

(52) U.S. Cl. CPC B60L 58/13; H04W 4/46

(57) ABSTRACT

Systems, methods, and other embodiments described herein relate to the completion of (VMC) tasks by an electric vehicle (EV) based on a battery state of charge (SOC). In one embodiment, a method includes forming a VMC that includes a group of interconnected vehicles that share resources to complete tasks. The group includes an EV. The method also includes scheduling a time when the EV is to complete a planned task of the VMC based on a SOC of a battery of the EV. The method also includes providing data associated with the planned task to the EV.

### TECHNICAL FIELD

The subject matter described herein relates, in general, to electric vehicle participation in vehicular micro clouds and, more particularly, to the completion of tasks of the vehicular micro cloud by electric vehicles based on the state of charge of the electric vehicle battery.

### BACKGROUND

Vehicles are equipped with numerous sensors that increase the ease and safety of vehicle operation. For example, some vehicles include sensors that detect adjacent vehicles, predict adjacent vehicle paths, and can provide incident avoidance recommendations to the driver of an ego vehicle. More generally, the vehicle includes many sensors that collect information about the vehicle itself and the surrounding environment, which information can be processed as output to help vehicle drivers, other current or future road users, as well as others interested in the development and usage of the road infrastructure. In some cases, processing the sensor output to provide the driver-assisting information may burden a single vehicle's processing resources.

Accordingly, vehicles and infrastructure elements near one another on a road network may be formed into a vehicular micro cloud (VMC). Members of the VMC offer their respective resources (e.g., processing resources, memory resources, communication resources) to collaboratively perform different tasks such as computation tasks, data storage tasks, sensing tasks, and communication tasks. The vehicles share information via different types of vehicle-to-everything (V2X) networks, such as vehicle-to-vehicle (V2V) networks. The output associated with collaborative tasks is shared amongst the vehicular micro cloud members.

### SUMMARY

In one embodiment, example systems and methods relate to a manner of improving vehicular micro cloud (VMC) operations. In one embodiment, a VMC management system for scheduling tasks for an electric vehicle in the VMC is disclosed. The VMC management system includes one or more processors and a memory communicably coupled to the one or more processors. The memory stores instructions that, when executed by the one or more processors, cause the one or more processors to form a VMC that includes a group of interconnected vehicles that share resources to complete tasks. The group includes an electric vehicle (EV). The memory also stores instructions that, when executed by the one or more processors, cause the one or more processors to schedule a time when the EV is to complete a planned task of the VMC based on a state of charge (SOC) of a battery of the EV. The memory also stores instructions that, when executed by the one or more processors, cause the one or more processors to provide data associated with the planned task to the EV.

In one embodiment, a non-transitory computer-readable medium for scheduling tasks for an EV in the VMC and including instructions that, when executed by one or more processors, cause the one or more processors to perform one or more functions is disclosed. The instructions include instructions to form a vehicular micro cloud that includes a group of interconnected vehicles that share resources to complete tasks. The group includes an electric vehicle. The instructions also include instructions to schedule a time when the electric vehicle is to complete a planned task of the vehicular micro cloud based on a state of charge (SOC) of a battery of the electric vehicle. The instructions also include instructions to provide data associated with the planned task to the electric vehicle.

In one embodiment, a method for scheduling tasks for an electric vehicle in the VMC is disclosed. In one embodiment, the method includes forming a vehicular micro cloud that includes a group of interconnected vehicles that share resources to complete tasks. The group includes an electric vehicle. The method also includes scheduling a time when the electric vehicle is to complete a planned task of the vehicular micro cloud based on a state of charge (SOC) of a battery of the electric vehicle. The method also includes providing data associated with the planned task to the electric vehicle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A and 1B illustrate the formation of a VMC that includes an EV.

FIG. 2 illustrates one embodiment of a vehicle within which systems and methods disclosed herein may be implemented.

FIG. 3 illustrates one embodiment of a VMC management system that is associated with scheduling tasks for an EV in the VMC.

FIG. 4 illustrates one embodiment of the VMC management system of FIG. 3 implemented in a remote server-based environment.

FIG. 5 illustrates a flowchart for one embodiment of a method that is associated with scheduling tasks for an EV in the VMC.

FIGS. 6A-6E illustrate the operations of the VMC management system in scheduling tasks for an EV in the VMC.

### DETAILED DESCRIPTION

Systems, methods, and other embodiments associated with improving vehicular micro cloud (VMC) operation are disclosed herein. As previously described, a VMC is a network of connected vehicles that cooperate to complete tasks and share their computing, communication, storage, and other resources. For example, roadway navigation can be dangerous due to road surface conditions, the behavior of other vehicles, and/or objects on the roadway, exposing the occupants in vehicles to various threats. Vehicle perception systems may enhance driver safety by relaying information about detected environmental conditions. However, the perception system of a single vehicle may be limited in its ability to capture information about the environment. Accordingly, a VMC may aggregate groups of vehicles to provide driver assistance by expanding the region about which environmental data may be collected. The aggregated resources of the VMC may be used for other purposes, including providing a broader perception of the environment and conditions on the road networks and providing additional storage and processing resources so that more complex operations can be performed more quickly.

While one specific example of a task of a VMC is described herein, there are other situations where it may be desirable to share the computing, communication, and storage resources of multiple vehicles in a group. Each VMC may be made up of vehicular micro cloud members (i.e., vehicles and/or roadside infrastructure elements) that contribute their resources to completing a task), and a vehicular micro cloud leader that assigns tasks to vehicular micro cloud members and distributes the collective output (e.g., threat-mitigating actions such as changing a lane or altering a speed responsive to a detected threat) to the VMC members.

However, completion of these tasks may consume energy, which may be problematic for battery electric vehicles (BEVs) or other types of EVs such as plug-in hybrid electric vehicles (PHEVs) and fuel cell electric vehicles (FCEVs) which also include a battery. An EV is a vehicle that is powered by an electric motor for propulsion rather than an internal combustion engine. In some cases, performing a VMC task may reduce the EV battery state of charge (SOC) to a point where the EV cannot reach a destination that it otherwise could or may simply change the reported SOC by a degree that negatively impacts the operation of the EV or a consumer's experience with the EV and/or EV technology. For example, upon entering an EV, the EV may indicate to the driver that the battery has a SOC of 25% (i.e., 25% of full capacity), which a driver may rely on in deciding whether they can reach an intended destination. As the EV travels, it may become part of a VMC and be asked to execute a particular task, which may consume energy and result in a drop to SOC of 5%. Accordingly, the driver relying on the reported SOC level to reach their intended destination may no longer be able to reach the intended destination because of the consumption of battery power by a processor completing the VMC task.

In some cases, the driver may still be able to reach their intended destination, but with a reported SOC different from an originally predicted amount. For example, when driving home from work, a driver may, with time, determine that their SOC changes 15% for this itinerary. Accordingly, on a particular day when the driver leaves work and sees a SOC of 25%, they may be confident that they will reach home. However, if tasks are executed that consume power, and the driver notices their SOC at home to be 5% (i.e., a consumption of 20% of battery power rather than the expected 15%), the driver may lose confidence in the SOC reporting, which could lead to reduced use of the EV or replacement of the EV with a non-electric vehicle. In summary, for any EV, a reported range of the EV is particularly relevant as a driver relies on this prediction to determine how far they can/should travel. Any calculation error or change to the predicted/expected range may reduce the confidence that drivers and others in electric vehicles have in electric vehicles. In other words, the discrepancies in energy consumption/energy availability may negatively impact the performance of EVs and negatively bias drivers of the EVs.

Moreover, based on the effect of VMC tasks on battery consumption, EV drivers may elect not to join a VMC due in part to a perceived incompatibility of EVs and the VMC (for example, due to a perceived overdraw on the EV battery while a member of a VMC). As VMC utility and efficacy depend on the number of vehicular micro cloud members in the VMC, discouraging EV involvement in a VMC may reduce the efficacy and utility of VMCs to all vehicular micro cloud member vehicles and the VMC environment in general.

The system of the present specification integrates EVs (e.g., BEVs and PHEVs) into the VMC by facilitating task completion in a way that reduces the effect of task-based energy consumption discrepancies. In general, the system assigns VMC tasks to an EV based on the battery level of the EV. If the SOC of the battery would be negatively impacted by more than a desired degree, the EV may be assigned to complete a VMC task that can be performed remotely. In this example, the EV stores, carries, and performs the given tasks at a later point in time when its SOC is sufficiently high, for example, when connected to an EV charging station.

Specifically, a VMC is formed that includes at least one EV as a vehicular micro cloud member. The vehicular micro cloud leader or a remote server identifies VMC tasks to be completed, including a VMC task to be completed by the vehicular micro cloud member EV. Based on at least a SOC of the battery, and in some cases additional information such as a drop in the SOC that would result from execution of the task and/or an intended destination of the EV, the vehicular micro cloud leader, or the remote server determines whether the EV should complete the task immediately while in the VMC or at a later point in time, for example when the SOC is greater than a threshold amount (e.g., when connected to a charging station). If the SOC is sufficient that the task may be completed immediately, the vehicular micro cloud leader or remote server sends data to the EV that allows the EV to complete the task (e.g., metadata associated with the task, a description of the task, and procedures, instructions, and/or code to complete the task and report results/output of the completed task). If the SOC is below a threshold level, if the energy consumption associated with the task would trigger an above-threshold change to the SOC, or if the EV would not be able to reach its intended destination based on the task-based change to the SOC, the EV, vehicular micro cloud leader, or remote server may schedule the task to be completed by the EV at a later point in time, such as when the EV is connected to a charging station. Specifically, the vehicular micro cloud leader or remote server may identify a task that could be completed at a later point in time and assign this subsequently-completable task to the EV. In this case, the vehicular micro cloud leader or remote server sends data to the EV that allows the EV to complete the task that is to be completed at a later point in time. In either case, once the EV completes the task, the vehicular micro cloud leader or remote server may receive an output of the task and/or report that the task has been completed. In either case (i.e., “contributing now” or “contributing later”), the collaborative output of the VMC is provided to the EV. For example, for a VMC task of providing instructions to a driver to avoid a recklessly driven adjacent vehicle, even if the EV is instructed to perform a remotely-completable task, the EV may be provided with navigation instructions to avoid the recklessly-driven vehicle, notwithstanding the EV contribution to the task occurs after the provided navigation instructions are promulgated through the group. In summary, the system 1) analyzes the scheduled VMC tasks, 2) selects either a “contribute now” or a “contribute later remotely” option based on EV battery level, and 3) determines which tasks from the ongoing micro cloud collaboration can be completed remotely by EVs. When “contributing later” is selected, the system 1) transfers data associated with a task to an EV and 2) instructs the EV to complete its task when connected to a charging station.

In this way, the disclosed systems, methods, and other embodiments improve VMC operation. Specifically, the present system facilitates the inclusion of EVs in a VMC, which 1) enhances the functionality of the VMC, 2) distributes the task amongst more vehicles, thus reducing the per-vehicle load for the VMC task, and 3) reduces the range-altering impact of VMC task execution by an EV (e.g., the change to SOC may be to an amount that does not alter user confidence and/or ensures that the driver still reaches its intended destination).

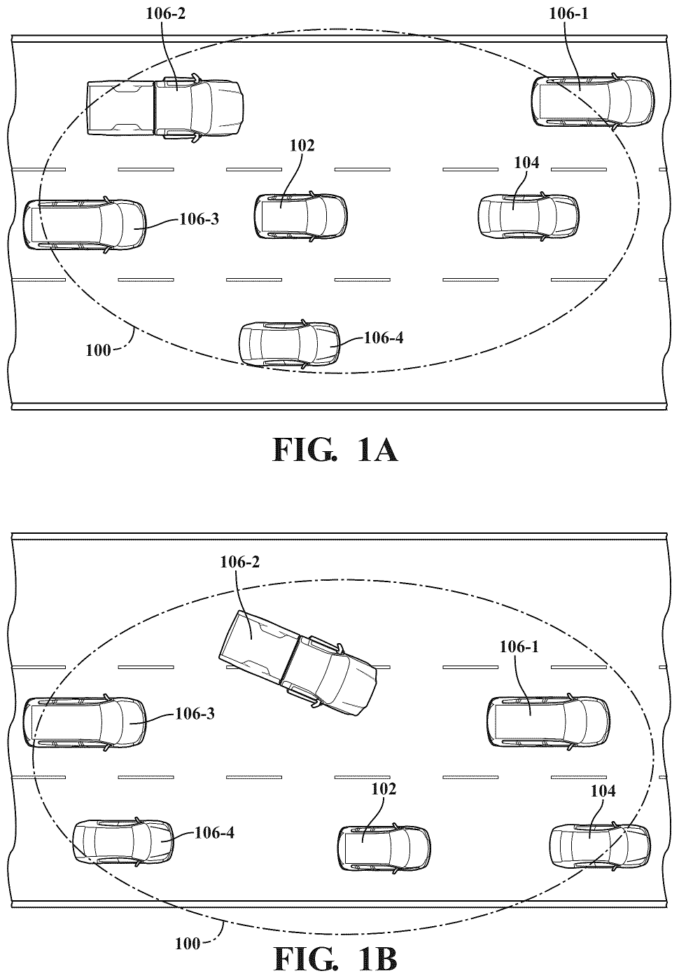

Turning now to the figures, FIGS. 1A and 1B illustrate the formation of a vehicular micro cloud (VMC) 100 that includes an electric vehicle (EV) 102. As described above, an EV 102 is a vehicle that uses electrical power to move. In general, the term EV includes battery electric vehicles (BEVs) and plug-in hybrid electric vehicles (PHEVs). A relevant operational consideration for EVs 102 is their range, or the distance that the EV 102 can travel, given a current battery SOC. That is, over time, the capacity of a battery drops, and the distance the EV 102 can travel is limited. A driver may make driving decisions based on the EV SOC. For example, the EV 102 may indicate to the driver a battery SOC or a distance range of the EV 102. In this example, a driver may decide not to travel to a particular destination as such may be beyond the reach of the EV 102, given the current SOC or distance range. By comparison, the driver may complete the journey if the battery SOC or distance range estimated by the EV 102 is greater than the distance to be traveled.

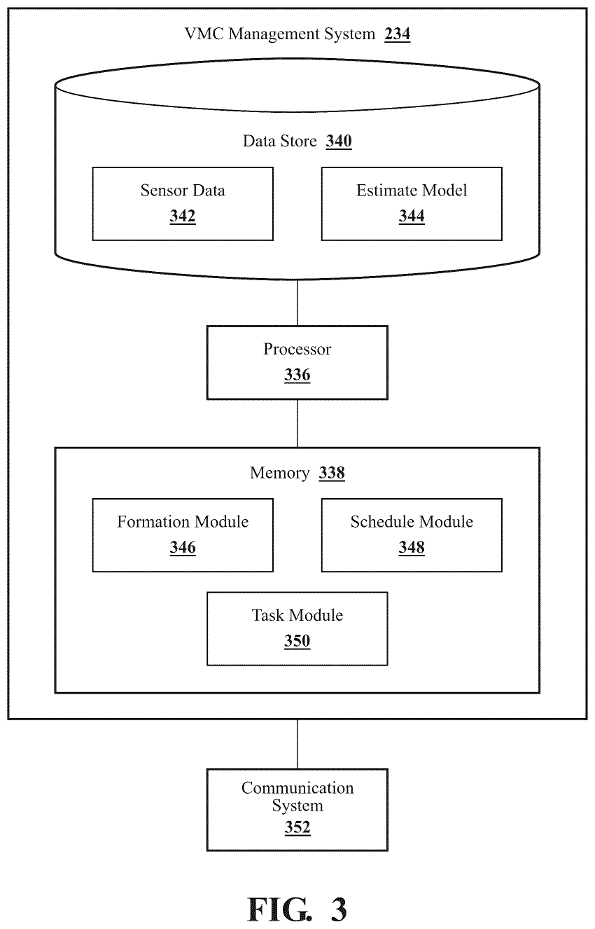

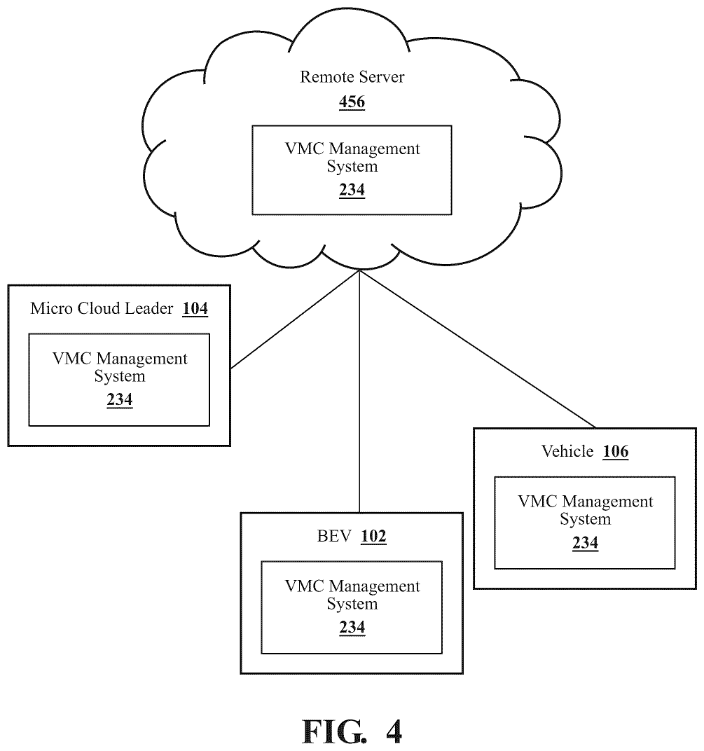

FIGS. 1A and 1B also depict a VMC 100, which, as described above, is a group of vehicles that share vehicle processing, communication, or storage resources to complete a particular task or combination of tasks. In general, the VMC 100 may include a vehicular micro cloud leader 104, which is a vehicle that in some way manages the operation of the VMC 100. For example, the vehicular micro cloud leader 104 may receive requests for VMC tasks to be completed, assign sub-tasks to particular vehicular micro cloud members, receive the output/results of a completed task, and promulgate the output results to the vehicular micro cloud members. In the context of the present application, the vehicular micro cloud leader 104 may, in some examples, assign tasks based on EV 102 battery SOC. Additional detail on how the vehicular micro cloud leader 104 performs such is described below in connection with FIGS. 3 and 4. As described, the VMC 100 may include the EV 102 and other vehicles 106-1, 106-2, 106-3, and 106-4, which may or may not be EVs.

As described above, through the VMC 100, vehicles share resources. Examples of resources include memory, processing, and network bandwidth resources, among others. Examples of tasks that may be completed by a vehicle in the VMC 100 include executing software for a connected vehicle, executing calculations for a connected vehicle, sending/receiving messages for a connected vehicle, finding digital data for a connected vehicle that is stored by any vehicular micro cloud member of the VMC 100, getting different vehicular micro cloud members of the vehicular micro cloud to help a connected vehicle with calculations, etc. Examples of shared information include image frames and/or video feeds from image sensors, image processing results from image frames and/or video frames, object detection results from proximity sensors, GPS coordinates, and computation results from subsystems processing data from sensor sets.

While particular reference is made to particular tasks, various other subtasks may be completed by the vehicular micro cloud members (i.e., vehicles 106-1, 106-2, 106-3, 106-4, EV 102, and vehicular micro cloud leader 104) of the VMC 100. When the various vehicular micro cloud members complete these tasks, the vehicular micro cloud leader 104 provides the output to the vehicular micro cloud members. That is, the vehicular micro cloud leader 104 or a remote server aggregates data/output from the vehicular micro cloud members to provide collaborative results relevant to the requested task. Examples of tasks completed by the VMC 100, the output of which is transmitted to vehicular micro cloud members, include dynamic map generation, cooperative path planning, and distributed data storage.

In an example, the vehicular micro cloud members of the VMC 100 may share their computing, communication, or storage resources through a vehicle-to-everything (V2X) network that enables vehicles to wirelessly communicate via one or more communication protocols. Examples of V2X networks include Dedicated Short Range Communication (DSRC) networks (including Basic Safety Messages (BSMs) and Personal Safety Messages (PSMs), among other types of DSRC communication); Bluetooth® networks, Long-Term Evolution (LTE) networks; millimeter wave (mmWave) communication networks; 3G networks; 4G networks; 5G networks; LTE-V2X networks; 5G-V2X networks; LTE-Vehicle-to-Vehicle (LTE-V2V) networks; LTE-Vehicle-to-Infrastructure (LTE-V2I) networks, LTE-Vehicle-to-Network (LTE-V2N) networks, LTE-Device-to-Device (LTE-D2D) networks; Voice over LTE (VoLTE) networks; etc. In some examples, the V2X communications can include V2V communications, Vehicle-to-Infrastructure (V2I) communications, Vehicle-to-Network (V2N) communications, or any combination thereof. While particular reference is made to particular communication modalities of the VMC 100, the communication network may include other interconnected paths across which multiple vehicles may communicate including other cellular or mobile communications networks. In another example, the VMC 100 may be other than a V2X network.

In some embodiments, each vehicular micro cloud member of the VMC 100 (e.g., the EV 102, the vehicular micro cloud leader 104, and other vehicles 106-1, 106-2, 106-3, and 106-4 join the VMC 100 via a handshake process with the coordinator of the VMC 100). In some embodiments, the memory of each vehicular micro cloud member stores vehicular micro cloud member data. The vehicular micro cloud member data may be digital data that describes one or more of the following: the identity of each of the vehicular micro cloud members; what digital data, or bits of data, are stored by each vehicular micro cloud member; what computing services are available from each vehicular micro cloud member; what computing resources are available from each vehicular micro cloud member and what quantity of these resources are available; and how to communicate with each vehicular micro cloud member. In some embodiments, the vehicular micro cloud member data may also describe logical associations between vehicles.

There are various types of VMCs 100. A stationary VMC 100 is a VMC 100 that is tied to a fixed geographical region (e.g., an intersection). A vehicle joins a stationary VMC 100 and contributes its resources upon entering the fixed geographical region as determined by a GPS sensor of the vehicle. Vehicles leave a stationary VMC 100 upon exiting from the fixed geographical region. When exiting from the fixed geographical region, the vehicle may hand over ongoing tasks and data of the stationary VMC 100 to other vehicular micro cloud members.

Another example is a mobile VMC 100 where a VMC 100 is formed around a particular vehicle (e.g., a vehicular micro cloud leader 104), and vehicles within a threshold distance of the particular vehicle are made vehicular micro cloud members of the VMC 100 via a handshake operation. As the particular vehicle may be moving, the geographic location of the mobile VMC 100 may change with the movement of the particular vehicle and other vehicular micro cloud members of the VMC 100. A vehicle can join the mobile VMC 100 when the connected vehicle is in an area covered by the mobile VMC 100. The vehicle can leave the mobile VMC 100 when the vehicle exits the area covered by the mobile VMC 100. In this example, a vehicular micro cloud leader 104 may advertise the VMC 100, and vehicles within a threshold distance of the vehicular micro cloud leader 104 may participate in the VMC 100.

As another example, consecutive interdependent VMCs 100 may be formed along a roadway section to execute particular tasks. For example, it may be the case that one mobile VMC 100 is not sufficient to carry out a task, such as defining a model of the behavior of vehicles on a particular stretch of a highway. Accordingly, as a vehicular micro cloud leader 104 travels along the road, it passes through different VMCs 100, and the different VMCs 100 perform different tasks such that the output of the different VMCs 100 may be used to generate a larger output that spans multiple regions associated with individual VMCs.

In yet another example, the VMC 100 may be a remote VMC 100 where an ego vehicle can be connected to other vehicles that are remote from the ego vehicle. In this example, the ego vehicle may be a remote vehicular micro cloud leader 104 and remotely control the collaboration of the vehicular micro cloud members. For example, an ego vehicle in one city may want to know the parking availability in a city spaced apart from the city where the ego vehicle is located. In this example, the ego vehicle could form a VMC 100 with vehicles in the target city, which vehicles in the target city, using exterior sensors, could indicate parking availability to the ego vehicle. While particular types of VMCs 100 are described herein, different types of VMCs 100 may be implemented in accordance with the principles described herein.

As described above, the VMC 100 may include a vehicular micro cloud leader 104 that forms and updates the VMC 100. In the context of the present specification, the vehicular micro cloud leader 104 may determine which computing resources of which vehicular micro cloud member vehicles are used to complete a task, identify those tasks that are remotely computable, and identify those tasks that are to be assigned to an EV 102 to be remotely completed when the EV SOC is greater than a threshold amount. For example, the driver of a particular vehicle may want to know the conditions of a road section along with the vehicle is travelling. In this example, the particular vehicle may trigger the formation of a VMC 100 (thus becoming the vehicular micro cloud leader 104) and broadcast formation of the VMC 100 via a local communication network (e.g., V2V communication network). Vehicles near the broadcast may join, and in some examples optionally opt out of, the VMC 100 and connect to the vehicular micro cloud leader 104, thus becoming vehicular micro cloud members.

In a more detailed example, the particular vehicle (which may ultimately become the vehicular micro cloud leader 104) may request a task to a server such as an edge server or remote server. The request may include formation rules identifying the task to be completed and a target geographic region and/or location for the VMC 100. In response, the server may select a geographic region based on the target geographic region and set the particular vehicle as the vehicular micro cloud leader 104. The server and/or the vehicular micro cloud leader 104 may identify vehicles within the target region, for example, based on GPS coordinates of the vehicles.

Each vehicle within the identified target region may receive an invitation to join a VMC 100, for example, through communication with a remote server or the vehicular micro cloud leader 104. The invitation to join the VMC 100 may indicate a collaborative task for which the VMC 100 is formed and, in some examples, an indication of resources to be shared. The vehicular micro cloud leader 104 and/or the remote server then forms the VMC 100, for example, via a V2V handshake operation.

As described above, a VMC 100 may be used for various tasks. FIG. 1B depicts one such task. It may be the case that a particular driver on the road operates their vehicle erratically in a way that poses a risk to adjacent vehicles. In this example, it may be desirable to advise certain vehicles to change their speed and/or change lanes to increase the distance between themselves and the erratically-operated vehicle. For example, it may be determined that a second vehicle 106-2 is exhibiting a pattern of drifting over lane lines and may be driving at a speed above a posted speed limit to a degree that poses a danger to adjacent vehicles. In this example, some vehicles in the VMC 100 may benefit from the enhanced perception of the second vehicle 106-2 by other vehicles in the VMC 100. For example, a fourth vehicle 106-4 may have environment sensors, but these sensors may be unable to detect the behavior of the second vehicle 106-2 on account of the distance between the second vehicle 106-2 and the fourth vehicle 106-4 and the blocking of the fourth vehicle 106-4 sensors by the EV 102. Accordingly, in this example, the vehicular micro cloud leader 104 may pool the environmental output by multiple vehicles in the VMC 100, including the EV 102, and generate a risk analysis and recommended action for the fourth vehicle 106-4 and other vehicles in the VMC 100. As such, the vehicular micro cloud leader 104 aggregates the environmental sensor output of multiple vehicles and any processing of the environmental sensor output to determine navigation guidance for the vehicles to avoid the second vehicle 106-2.

As another example, a vehicle in a first location (e.g., Detroit) may desire to know the parking conditions in a particular parking lot in another location (e.g., Ann Arbor). In this example, the vehicle in the first location may form a VMC 100 with vehicles in the parking lot in the second location to ascertain parking availability. While particular reference is made to particular VMC 100 tasks, the VMC 100 may be initiated or triggered to complete various tasks.

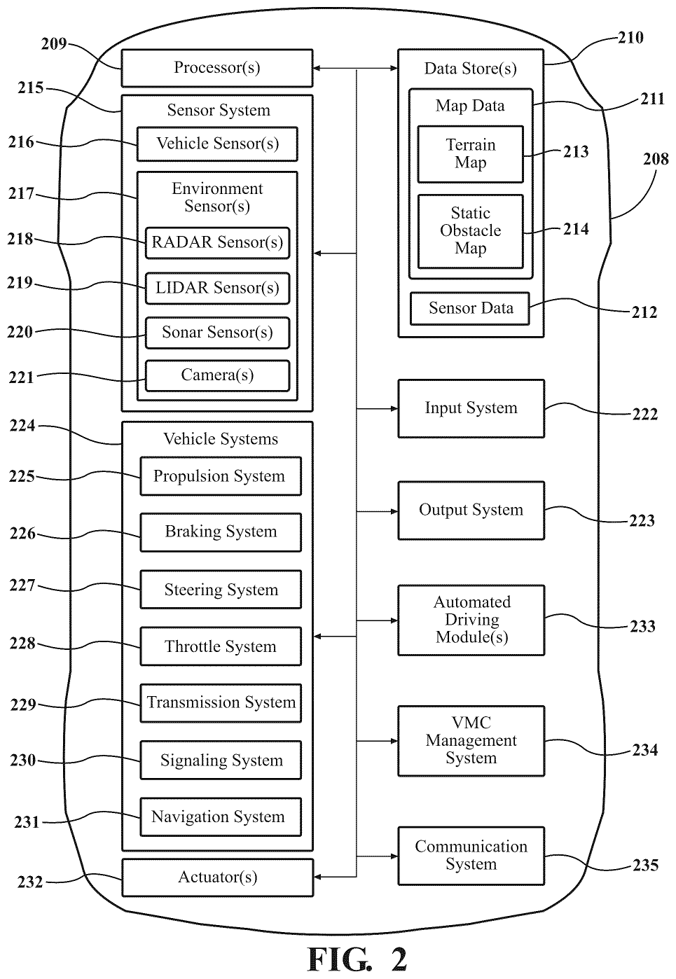

FIG. 2 illustrates one embodiment of a vehicle 208 within which systems and methods disclosed herein may be implemented. In some examples, the VMC management system 234 may be disposed in a vehicle 208; in other examples, the VMC management system 234 may be disposed at a remote server. In an example, vehicle 208, on which the VMC management system 234 is disposed, may be the vehicular micro cloud leader 104.

Referring to FIG. 2, an example of a vehicle 208 is illustrated. As used herein, a “vehicle” is any form of transport that may be motorized or otherwise powered. In one or more implementations, the vehicle 208 is an automobile. While arrangements will be described herein with respect to automobiles, it will be understood that embodiments are not limited to automobiles. In some implementations, the vehicle 208 may be a robotic device or a form of transport that, for example, includes sensors to perceive aspects of the surrounding environment and thus benefits from the functionality discussed herein associated with forming VMCs 100 based on vehicle 208 battery life.

The vehicle 208 also includes various elements. It will be understood that in various embodiments it may not be necessary for the vehicle 208 to have all of the elements shown in FIG. 2. The vehicle 208 can have different combinations of the various elements shown in FIG. 2. Further, the vehicle 208 can have additional elements to those shown in FIG. 2. In some arrangements, the vehicle 208 may be implemented without one or more of the elements shown in FIG. 2. While the various elements are shown as being located within the vehicle 208 in FIG. 2, it will be understood that one or more of these elements can be located external to the vehicle 208. Further, the elements shown may be physically separated by large distances. For example, as discussed, one or more components of the disclosed system can be implemented within a vehicle while further components of the system are implemented within a cloud-computing environment or other system that is remote from the vehicle 208.

Some of the possible elements of the vehicle 208 are shown in FIG. 2 and will be described along with subsequent figures. However, a description of many of the elements in FIG. 2 will be provided after the discussion of FIGS. 2-6E for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 208 includes a VMC management system 234 that is implemented to perform methods and other functions as disclosed herein relating to improving VMC 100 operations.

As will be discussed in greater detail subsequently, the VMC management system 234, in various embodiments, is implemented partially within the vehicle 208 and as a remote service. For example, in one approach, functionality associated with at least one module of the VMC management system 234 is implemented within the vehicle 208, while further functionality is implemented within a remote server. Thus, the VMC management system 234 may include a local instance at the vehicle 208 and a remote instance that functions within the remote server. That is, the operations of the modules of the VMC management system 234 may be performed at the vehicle 208, the remote server, or a combination of the two.

Moreover, the VMC management system 234, as provided for within the vehicle 208, functions in cooperation with a communication system 235. In one embodiment, the communication system 235 communicates according to one or more communication standards. For example, the communication system 235 can include multiple different antennas/transceivers and/or other hardware elements for communicating at different frequencies and according to respective protocols. The communication system 235, in one arrangement, communicates via a communication protocol, such as a WiFi, DSRC, V2I, V2V, or another suitable protocol for communicating between the vehicle 208 and other entities in the cloud environment such as those mentioned above. Moreover, the communication system 235, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 208 communicating with various remote devices (e.g., a cloud-based server). In any case, the VMC management system 234 can leverage various wireless communication technologies to provide communications to other entities, such as vehicular micro cloud members of the cloud-computing environment.

With reference to FIG. 3, one embodiment of the VMC management system 234 of FIG. 2 is further illustrated. The VMC management system 234 is shown as including a processor 336. As described above, in an example, the VMC management system 234 may be disposed in the vehicle 208. In this example, the processor 336 may be a part of the VMC management system 234, the VMC management system 234 may include a separate processor from the processor 209 of the vehicle 208, or the VMC management system 234 may access the processor 209 through a data bus or another communication path that is separate from the vehicle 208. In another example, the VMC management system 234 is disposed on a remote server, as depicted in FIG. 4.

In one embodiment, the VMC management system 234 includes a memory 338 that stores a formation module 346, a schedule module 348, and a task module 350. The memory 338 is a random-access memory (RAM), read-only memory (ROM), a hard-disk drive, a flash memory, or another suitable memory for storing the modules 346, 348, and 350. The modules 346, 348, and 350 are, for example, computer-readable instructions that, when executed by the processor 336, cause the processor 336 to perform the various functions disclosed herein. In alternative arrangements, the modules 346, 348, and 350 are independent elements from the memory 338 that are, for example, comprised of hardware elements. Thus, the modules 346, 348, and 350 are alternatively ASICs, hardware-based controllers, a composition of logic gates, or another hardware-based solution.

The VMC management system 234, as illustrated in FIG. 4, is generally an abstracted form of the VMC management system 234 as may be implemented between the vehicles (e.g., the vehicular micro cloud leader 104, the EV 102, other vehicles 106 in the VMC 100) and a remote server 456. FIG. 4 illustrates one example of a remote server that may be implemented along with the VMC management system 234. As illustrated in FIG. 4, the VMC management system 234 is embodied at least in part within the remote server 456.

In one or more approaches, the cloud environment may facilitate communications between multiple different vehicles to acquire and distribute information between vehicles (e.g., the vehicular micro cloud leader 104, the EV 102, and other vehicles 106 in the VMC 100).

Accordingly, as shown, the VMC management system 234 may include separate instances within one or more entities of the cloud-based environment, such as a remote server 456, and also instances within vehicles that function cooperatively to acquire, analyze, and distribute the noted information. In a further aspect, the entities that implement the VMC management system 234 within the cloud-based environment may vary beyond transportation-related devices and encompass roadside infrastructure elements, and thereby can function in cooperation with the vehicle 208. Thus, the set of entities that function in coordination with the cloud environment may be varied.

The cloud-based environment itself, as previously noted, is a dynamic environment that comprises vehicular micro cloud members that are routinely migrating into and out of a geographic area, such as near an intersection or a vehicular micro cloud leader 104.

Moreover, in one embodiment, the VMC management system 234 includes the data store 340. The data store 340 is, in one embodiment, an electronic data structure stored in the memory 338 or another data storage device and that is configured with routines that can be executed by the processor 336 for analyzing stored data, providing stored data, organizing stored data, and so on. Thus, in one embodiment, the data store 340 stores data used by the modules 346, 348, and 350 in executing various functions.

Specifically, the data store 340 may include sensor data 342 collected by the various sensors of the vehicles in the VMC 100. Of particular relevance, the sensor data 342 may include data indicative of the SOC of the EV battery. The data indicative of SOC may take a variety of forms. For example, the SOC may indicate an absolute measure of energy available in the battery. In another example, the SOC may indicate a percentage of the battery that remains to power the EV 102. For example, the SOC may indicate that the battery is 80% of full capacity, 60% of full capacity, 40% of full capacity, or any other value. The sensor data 342, particularly the battery data, may be acquired in various ways. For example, the schedule module 348, whether on a remote server 456 or at the vehicle 208, may query the EV 102 for its battery SOC. That is, the EV 102 may include a sensor or other processing resource that determines the amount of battery left and available to charge components of the EV 102. This information may be transmitted to the remote server 456 or vehicular micro cloud leader 104 periodically or on demand.

In one embodiment, the data store 340 stores the sensor data 342 along with, for example, metadata that characterizes various aspects of the sensor data 342. For example, the metadata can include location coordinates (e.g., longitude and latitude), relative map coordinates or tile identifiers, time/date stamps from when the separate sensor data 342 was generated, and so on.

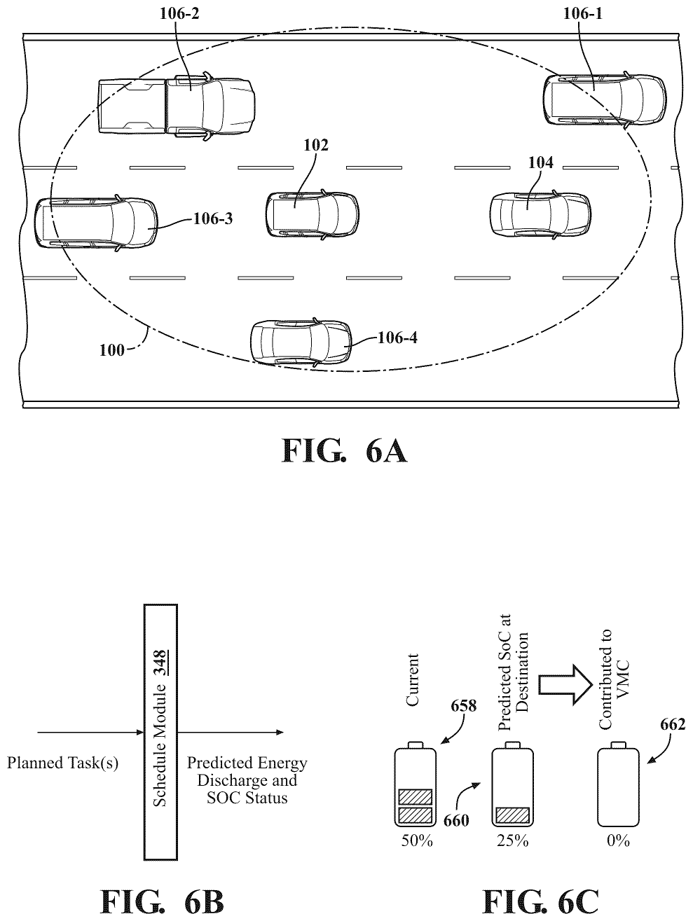

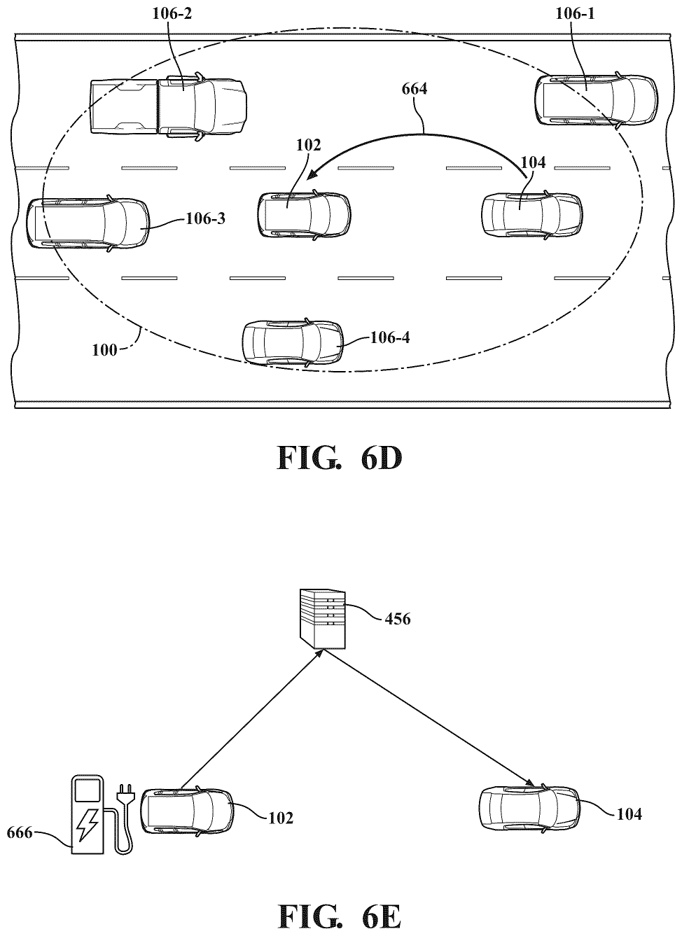

In one embodiment, the data store 340 further includes an estimate model 344. As described in greater detail below and in connection with FIG. 6, the schedule module 348 determines when the EV 102 should complete an assigned VMC 100 task based on the battery life, or SOC, of the EV 102 battery. The estimate model 344 may be a model that the schedule module 348 relies on in determining whether the EV 102 performs a sub-task upon assignation or waits until the EV 102 is in a higher SOC state before completing the sub-task. As will be described below, such a determination may be based on 1) the SOC state of the battery, 2) the energy discharge associated with a particular task, and/or 3) an intended destination of the EV 102. Accordingly, in one example the estimate model 344 includes a lookup table that maps these characteristics (e.g., SOC state of the battery, energy discharge per task, and distance to intended destination) to a determination of whether the EV 102 should complete a task upon assignation or later. In an example, the lookup table may be indexed by vehicle and/or vehicle characteristics. That is, certain vehicles may experience more battery drain for a given task than another vehicle. This may be based on the vehicle and/or battery size. For example, an EV 102 sedan may have a greater SOC change (as a percentage of full capacity) for a given task than a truck, which may have a larger battery. Accordingly, a lookup table-based estimate model 344 may account for these and other factors.

In another example, the schedule module 348 may determine whether a particular EV 102 performs a task based on machine-learning analysis of the sensor data 342. That is, the VMC management system 234 may be a machine-learning system. A machine-learning system generally identifies patterns and/or deviations based on previously unseen data. In the context of the present application, a machine-learning VMC management system 234 relies on some form of machine learning, whether supervised, unsupervised, reinforcement, or any other type, to determine whether the EV 102 should perform the task upon assignation or at a later point in time based on any number of selection criteria. In an example, the estimate model 344 is a supervised model where the machine learning is trained with an input data set and optimized to meet a set of specific outputs. In another example, the estimate model 344 is an unsupervised model where the model is trained with an input data set but not optimized to meet a set of specific outputs; instead, it is trained to classify based on common characteristics. As another example, the estimate model 344 may be a self-trained reinforcement model based on trial and error.

In this example, the schedule module 348 may receive various inputs such as SOC, distance to a particular intended destination, vehicle characteristics, environment characteristics, etc., and generate, as an output, whether a particular EV 102 should perform the completed task when assigned, or wait until the EV 102 is at a higher battery SOC, for example when connected to a charging station. The estimate model 344 includes the weights (including trainable and non-trainable), biases, variables, offset values, algorithms, parameters, and other elements that operate to output a suggested schedule for task completion based on any number of input values including sensor data 342 and driver/environmental conditions as described above. Examples of machine-learning models include but are not limited to, logistic regression models, Support Vector Machine (SVM) models, naïve Bayes models, decision tree models, linear regression models, k-nearest neighbor models, random forest models, boosting algorithm models, and hierarchical clustering models. While particular models are described herein, the estimate model 344 may be of various types intended to determine whether an EV 102 should complete a task upon assignation or at a later point in time.

The formation module 346, in one embodiment, includes instructions that cause the processor 336 to form a VMC 100 that includes a group of interconnected vehicles that share resources to complete tasks. As described above, the group includes an EV 102, which may be particularly susceptible to the energy-draining effects of task completion. For this reason and others, the VMC management system 234 may particularly consider the EV 102 battery state when assigning tasks. Regardless of whether an EV 102 is assigned a task, the EV 102 may form part of the VMC 100. That is, the VMC 100 may output information/messages to all vehicular micro cloud members. In this case, the EV 102 may receive the output information/message regardless of whether it completes a task.

As described above, formation occurs as vehicles fall within a geographic region, whether that geographic region is stationary (e.g., an intersection) or mobile (e.g., a moving vehicular micro cloud leader 104). Coordinates of the geographic region may be compared to the geographic coordinates of the vehicle, as collected from vehicle location sensors, to determine whether the vehicle is within the geographic region. For those vehicles within the geographic region, the formation module 346 may include instructions that cause the processor 336 to transmit a broadcast message inviting vehicles to join the VMC 100. Vehicles may automatically, or following user authorization, join the VMC 100. That is, the VMC 100 may have opt-in/opt-out functionality such that a vehicle in the geographic region may or may not join the VMC 100. In summary, the formation module 346 triggers, initiates and manages the handshake operation by which the VMC 100 is formed.

The VMC management system 234 also includes a schedule module 348 that, in one embodiment, includes instructions that cause the processor 336 to schedule a time when the EV 102 is to complete a planned task of the VMC 100 based on a SOC of a battery of the EV 102. That is, those resources of the EV 102 that are to be allocated to the completion of VMC tasks are scheduled based on the SOC of the battery, as too large an impact on the battery SOC may result in the EV 102 not reaching an intended destination or the SOC deviating enough that the driver loses confidence in the ability of the EV 102 to meet their transportation needs.

As the scheduling is based on the SOC, the schedule module 348 may determine the SOC of the battery, which may occur in various ways. In one example, the schedule module 348 may receive the SOC from the EV 102. That is, the EV 102 may include a sensor that monitors the SOC or state of the battery. Upon request via a push operation or periodically via a pull operation, the schedule module 348 (whether on the vehicle 208 or at a remote server 456) may acquire the SOC of the battery. Upon receipt of this information, the schedule module 348 may, via the estimate model 344, determine whether the EV 102 should complete a task upon receipt of the assignment from the vehicular micro cloud leader 104 or the remote server 456, or complete the task later. As described above, such a determination may be based on a lookup table that indicates, for a given SOC and other particular criteria, whether the EV 102 should complete a task. In another example, as described above, the determination may be based on a machine-learning analysis of various inputs, including the battery SOC and other driver, vehicle, and/or environmental considerations.

In another example, the schedule module 348 may receive an indication from the EV 102 of when the task is to be completed. That is, in this example, rather than receiving the EV SOC and determining when the task is to be completed, the EV 102 may determine its own SOC and determine, based on the estimate model 344 included in an EV instance of the VMC management system 234, whether the EV is to complete an assigned task upon assignation or whether the EV 102 will complete the task at a later point in time. In this example, scheduling includes receiving a message from the EV 102 that the EV 102 will be available to complete a VMC task at a later point in time, for example, when connected to a charging station. As described above, scheduling of a time to complete a task (e.g., whether to contribute resources upon assignation of a task or at a later point in time) may be based on different criteria, including 1) the SOC of the battery, 2) an energy discharge of an assigned task, and/or a 3) a distance to an intended destination of the EV 102. Additional details and examples of each are provided below in connection with FIG. 6.

In one approach, the schedule module 348 implements and/or otherwise uses a machine learning algorithm. A machine-learning algorithm generally identifies patterns and deviations based on previously unseen data. In the context of the present application, a machine-learning schedule module 348 relies on some form of machine learning, whether supervised, unsupervised, reinforcement, or any other type of machine learning, to identify patterns in task completion and energy consumption to advise whether the EV 102 should complete an assigned task upon completion or at a later point in time based on 1) the current battery SOC, 2) energy discharge per task, 3) an expected travel distance of the EV 102, and/or 4) vehicle, driver, and/or environmental conditions.

In one configuration, the machine learning algorithm is embedded within the schedule module 348, such as a convolutional neural network (CNN) or an artificial neural network (ANN) to perform task scheduling over the sensor data 342, from which further information is derived. Of course, in further aspects, the schedule module 348 may employ different machine learning algorithms or implement different approaches for performing the task scheduling, which can include logistic regression, a naïve Bayes algorithm, a decision tree, a linear regression algorithm, a k-nearest neighbor algorithm, a random forest algorithm, a boosting algorithm, and a hierarchical clustering algorithm among others to generate task schedules. Other examples of machine learning algorithms include but are not limited to deep neural networks (DNN), including transformer networks, convolutional neural networks, recurrent neural networks (RNN), Support Vector Machines (SVM), clustering algorithms, Hidden Markov Models, and so on. It should be appreciated that the separate forms of machine learning algorithms may have distinct applications, such as agent modeling, machine perception, and so on.

Whichever particular approach the schedule module 348 implements, the schedule module 348 improves VMC operation by introducing machine-learning processing of hundreds, thousands, or millions of pieces of data. For example, the schedule module 348 may receive information from hundreds, thousands, or tens of thousands of EVs 102. This complex data, which would be impossible to process otherwise, is processed through machine learning to identify patterns against which measured sensor data 342 (e.g., battery SOC) is compared. Thus, machine learning enables a more accurate inference of the effect of task execution on a battery SOC.

Moreover, it should be appreciated that machine learning algorithms are generally trained to perform a defined task. Thus, the training of the machine learning algorithm is understood to be distinct from the general use of the machine learning algorithm unless otherwise stated. That is, the VMC management system 234 or another system generally trains the machine learning algorithm according to a particular training approach, which may include supervised training, self-supervised training, reinforcement learning, and so on. In contrast to training/learning of the machine learning algorithm, the VMC management system 234 implements the machine learning algorithm to perform inference. Thus, the general use of the machine learning algorithm is described as inference.

It should be appreciated that the schedule module 348, in combination with the estimate model 344, can form a computational model such as a neural network model. In any case, the schedule module 348, when implemented with a neural network model or another model in one embodiment, implements functional aspects of the estimate model 344 while further aspects, such as learned weights, may be stored within the data store 340. Accordingly, the estimate model 344 is generally integrated with the schedule module 348 as a cohesive functional structure.

The VMC management system 234 also includes a task module 350 that, in one embodiment, includes instructions that cause the processor 336 to provide data associated with the planned task to the EV 102. That is, to perform a particular task, the EV 102 relies on certain information such as raw data to be acted upon, procedures, instructions, or code to perform the task (e.g., procedures, instructions, or code to control operation of various sensors/resources of the EV 102), and instructions for transmitting the output of such tasks and/or the results of the collaborative execution of tasks. In either example, (i.e., when the EV 102 is scheduled to complete the task upon assignment or when the EV 102 is scheduled to complete the task at a later point in time, for example, when connected to a charging station), the task module 350, whether of the vehicular micro cloud leader 104 or the remote server 456, the task module 350 provides this information that allows the EV 102 to complete the task.

In the case where a task is to be completed at a later point in time, the task module 350 may identify those tasks that are suitable to be completed remotely and after the initial request that triggered the formation of the VMC 100. For example, certain tasks are suited for remote completion while others are not. As a particular example, when doing risk assessment based on environmentally perceived objects, providing sensor output of a potentially dangerous situation may not be one that is completable remotely or subsequently as a lack of this data may negatively impact the risk assessment and/or remotely, and subsequently, collected sensor information may be irrelevant to a current situation. By comparison, providing updated parameters by which a machine-learning system may evaluate input sensor data may be transmittable at a later point in time.

As a particular example, it may be that a machine-learning system infers the future behavior of an adjacent vehicle from currently collected output images from an ego vehicle. However, it may be the case that the current machine-learning model incorrectly predicts future behavior. Accordingly, the vehicular micro cloud leader 104 may recommend updated parameters by which future behavior is predicted. In this example, transmitting the updated parameters may be appropriately sent after the situation has been resolved. As another example, it may be that the estimate model 344 maps a particular task to a particular energy discharge value, as described above. However, this mapping may be incorrect as currently-collected data for a vehicle in the VMC 100 demonstrates a second energy discharge value when executing the particular task. In this example, this updated energy discharge parameter may be sent at a later point in time as it may not be necessary to send such upon assignation of the task.

While particular reference is made to particular tasks that are remotely and subsequently executable, the task module 350 may identify other tasks that are remotely and subsequently executable. In some examples, this identification may be performed in various ways. For example, metadata associated with particular tasks may identify tasks as those remotely and subsequently executable.

In any case, the VMC management system 234 operates with a communication system 352. The communication system 352 may be similar to the communication system 235 found within the vehicle 208.

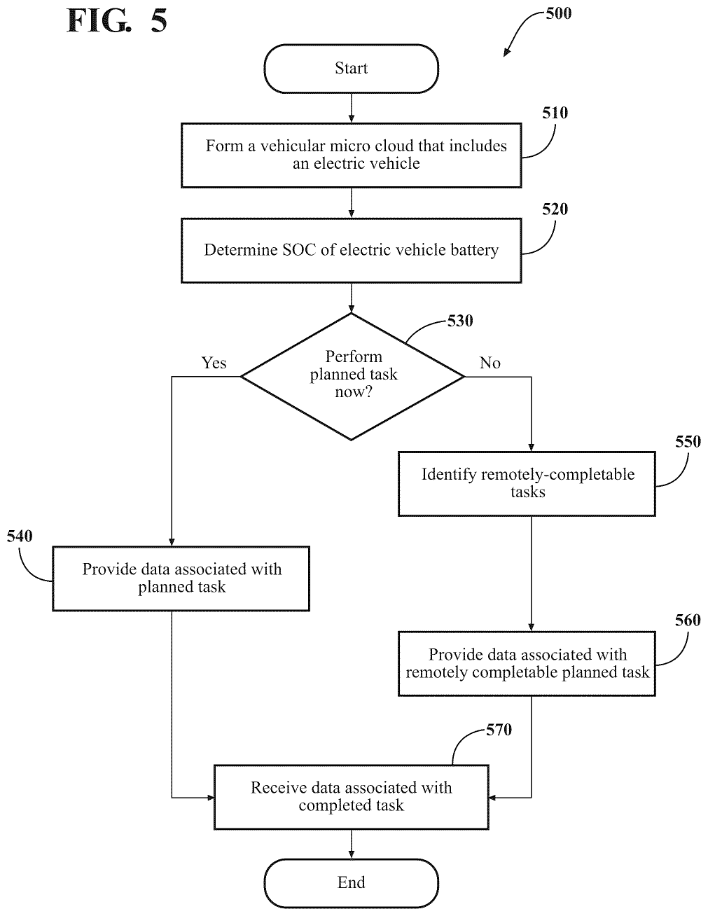

Additional aspects of incorporating an EV 102 into a VMC 100 will be discussed in relation to FIG. 5. FIG. 5 illustrates a flowchart of a method 500 that is associated with scheduling VMC tasks to an EV 102 based on a battery state of the EV 102. Method 500 will be discussed from the perspective of the VMC management system 234 of FIGS. 2 and 3. While method 500 is discussed in combination with the VMC management system 234, it should be appreciated that the method 500 is not limited to being implemented within the VMC management system 234 but is instead one example of a system that may implement the method 500.

At 510, the formation module 346 forms a VMC 100 that includes an EV 102. As described above, a VMC 100 is a collection of vehicles grouped together to pool computing, storage, and communication resources to complete VMC tasks. Accordingly, via a handshake operation, the formation module 346, whether at a remote server 456 or the vehicular micro cloud leader 104, forms a VMC 100 that includes an EV 102. As described above, the formed VMC 100 may vary depending on the circumstances. Example VMC types include a stationary VMC, a mobile VMC, a chain VMC, and a remote VMC.

At 520, the schedule module 348 determines the SOC of the EV battery. As described, this may include periodically querying the EV 102 or periodically receiving updates from the EV 102. In either example, at 530, the schedule module 348 determines whether to perform a planned task now (i.e., upon assignment of the task) or at a later point in time. That is, collaborative execution of tasks may include a variety of sub-tasks to be completed. At 530, the schedule module 348 analyzes the tasks planned for the VMC 100 and determines whether the EV 102 should complete an assigned task upon transmission of the request or at a later point in time. As described above, such scheduling may include 1) receiving an indication from the EV 102 as to whether the EV 102 will complete the task upon transmission of the request or at a later point in time or 2) making a calculation based on received SOC values and an estimate model 344. Determining whether the EV 102 is to complete the task upon assignation or at a later point in time (i.e., scheduling the time for the completion of the task) may be based on 1) the measured SOC of the battery, 2) an energy discharge associated with an assigned task, and/or 3) an estimated travel range and intended destination for the EV 102. Each will be discussed in turn.

First, the schedule module 348 may include instructions that cause the processor 336 to schedule the completion of the task based on the SOC of the battery. For example, if the EV SOC is great enough, any energy consumption via task completion may have a nominal effect on consumer confidence and EV 102 operation. Accordingly, if the battery SOC exceeds a threshold amount, an assigned task may be scheduled to be completed immediately. As a specific numeric example, the task may be executed immediately when battery SOC is greater than 30%. By comparison, if the battery SOC is less than 30%, the schedule module 348 may indicate that the EV 102 is to complete the task at a future point in time. While particular reference is made to particular threshold values, the system may utilize different threshold values as criteria to determine whether to perform a task now or later.

In another example, the schedule (i.e., whether a task is to be completed immediately or at a later point in time) is further based on the energy consumption associated with a particular task. That is, each task may consume a certain amount of battery power, and the schedule module 348 may consider this estimated amount. That is, the schedule module 348 includes instructions that cause the processor 336 to estimate an energy discharge value for the planned task. As described above, this estimation of the energy discharge value may be 1) based on a lookup table that maps energy discharge values to VMC tasks or 2) based on the execution of a machine-learning estimate of the energy discharge value.

In either case, the schedule module 348 may include instructions that cause the processor 336 to schedule the time for the EV 102 to complete the task based on the SOC and an estimated energy discharge value for the planned task. When the estimated energy discharge value for the planned task 1) reduces the SOC by a threshold discharge amount or 2) reduces the SOC to below a threshold SOC value, the schedule module 348 instructs the EV 102 to complete the planned task at a future time when the SOC is greater than the threshold SOC value.

As a specific example, if a planned task would reduce the SOC to less than 20% (as determined by the estimate model 344), the schedule module 348 may instruct the EV 102 to complete the task at a later point in time. By comparison, if after the scheduled task completion, the SOC would be above a certain value (e.g., 20%), the schedule module 348 may instruct the EV 102 to complete the task immediately upon assignment.

As another example, if a planned task would reduce the SOC by 10% (as determined by the estimate module 344), the schedule module 348 may instruct the EV 102 to complete the task at a later point in time. By comparison, if the planned task would reduce the SOC by 5% (as determined by the estimate model 344), the schedule module 348 may instruct the EV 102 to complete the task upon assignment. While particular reference is made to particular threshold values, the system may utilize different threshold values as criteria to determine whether to perform a task now or later.

In another example, the schedule (i.e., whether a task is to be completed immediately or at a later point in time) is further based on the intended destination of the EV 102. That is, the intended distance the driver of the EV 102 intends to travel may affect the relevance of any task-based change in SOC. For example, an EV 102 SOC dropping below a threshold amount or being changed by a threshold amount may be less relevant for a fully-charged EV 102 traveling a few minutes as compared to an EV 102 that is traveling for more than an hour.

Accordingly, in this example, the schedule module 348 includes instructions that cause the processor 336 to identify a destination of the EV 102, for example, via a transmitted message received from the navigation system of the EV 102. The schedule module 348 may include instructions that cause the processor 336 to schedule the time for the EV 102 to complete the task based on the SOC, the estimated energy discharge value for the planned task, and the intended destination of the electric vehicle.

The schedule module 348 includes instructions that cause the processor 336 to instruct the EV 102 to complete the planned task at a future time (e.g., when the SOC is greater than a threshold value for example when connected to a charging station) when the estimated energy discharge value for the planned task either 1) results in an estimated destination SOC deviation from an original destination SOC that is greater than a threshold deviation amount or 2) renders the EV 102 unable to reach the intended destination. Again, such a determination may be based on a lookup table or a machine-learning operation. In this example, the machine-learning system may receive as inputs, the current SOC and an intended destination and may have been trained on a training set of data that relates SOCs, energy discharge values associated with different tasks, and traveled distances. Accordingly, when an intended destination and SOC are received from the EV 102, the schedule module 348 may determine whether the EV 102 will likely reach an intended destination following the execution of the task. If not, the schedule module 348 may instruct the EV 102 to complete the task at a later point in time. If so, the schedule module 348 may instruct the EV 102 to complete the task upon receipt.

In another example, rather than basing a decision as to when to complete a task (e.g., complete now or at a later point in time), the schedule module 348 may evaluate whether the completion of the task would alter the SOC by a threshold amount. That is, a consumer may have, over time, developed an awareness of how far they can travel for a given SOC. If the performance of the VMC task alters the SOC by greater than a consumer-expected amount, the consumer may lose confidence in the EV 102 and not use the EV 102 or use the EV 102 less efficiently. Accordingly, if the deviation of the SOC at the destination is likely to be greater than a threshold amount from an expected SOC at the destination (not accounting for completion of the VMC task), the schedule module 348 may recommend completion of the task subsequently (e.g., when the EV 102 is connected to a charging station). By considering whether to assign a task to an EV 102 in the VMC 100, the current system ensures efficient and consumer-friendly operation of the EV 102, all while enhancing the functionality of the VMC 100 by increasing the pool of vehicles which may be connected and which may share their respective resources.

In either case, i.e., the EV 102 contributes immediately upon receipt of a task or remotely and subsequently completes the task, the EV 102 may receive the output of the VMC 100. That is, the VMC management system 234 may include instructions that cause the processor 336 to provide an output of the VMC 100 to the EV 102 independent of when the EV 102 completes the planned task. That is, the reception of VMC output is not dependent upon the EV 102 contributing resources/completing a task immediately upon reception of the task or while the EV 102 is in the geographic region that defines the VMC 100.

In any case, if the EV 102 is to complete a task/contribute a resource while the EV 102 is within the geographic region that defines the VMC 100 (530, decision YES), the schedule module 348 includes instructions that cause the processor 336 to instruct the EV 102 to immediately complete the planned task, based on the SOC being greater than a threshold amount, with such threshold amount being dependent upon the energy discharge associated with a particular task to be completed and/or a destination the EV 102 is traveling to or the range of the EV 102 battery. In this example, at 540, the task module 350 provides data associated with a planned task to the EV 102. As described above, the EV 102 may rely on certain data when completing a VMC task, such as raw data to analyze/store, instructions/code to perform the task, post-processing tasks for the tasks completed, etc. Accordingly, in this example, the vehicular micro cloud leader 104 may transfer this information to the EV 102.

If, however, the EV 102 is to complete the task at a later point in time when outside of the geographic region that defines the VMC 100 (530 decision, NO), the schedule module 348 may include instructions that cause the processor 336 to instruct the EV 102 to complete the planned task at a future time when the SOC is greater than the threshold amount, for example when the EV 102 is at a charging station.

Continuing this example, the task module 350 may include instructions that, at 550, cause the processor 336 to identify a remotely-completable planned task for the VMC 100 that is completable at a later point in time and at 560, cause the processor 336 to provide data associated with the remotely-completable planned task to the EV 102. That is, as described above, certain tasks may be completable after the vehicular micro cloud members have left the geographic region, while others are more suited for completion while in the geographic region. For example, in a stationary VMC 100 defined by an intersection, tasks associated with capturing images of the intersection may not be suitably performed when the EV 102 is outside of the geographic region. By comparison, post-processing of the images, or transmitting updated machine-learning parameters may. Accordingly, the vehicular micro cloud leader 104 or the remote server 456 identifies remotely-completable tasks. In an example, this may be based on metadata associated with the tasks or other information. The task module 350 then transfers information to the EV 102 that allows the EV 102 to complete the task, which information may include raw data, procedures, instructions, and/or code to perform the task, and instructions of what to do upon completion of the task.

As a particular example, it may be that the VMC 100 relies on a machine-learning model that is continually updated with feedback-related data. That is, the parameters of the machine learning model may be continually updated based on real-time collected information. For example, a risk reasoning model may be a machine-learning model. In this example, the EV 102 may be assigned the task of transmitting the updated machine-learning parameters to the vehicular micro cloud leader 104 or the remote server 456.

In either case (e.g., remotely performing the task or immediate performing the task upon assignment), at 570, the vehicular micro cloud leader 104 or the remote server 456 include instructions to receive data associated with a subsequently completed task from the EV 102. That is, the EV 102 performs its task and transmits the results/output of the task to the vehicular micro cloud leader 104/remote server 456 such that the collaborative output may be provided to the the vehicular micro cloud members. That is, the EV 102 receives a task from the vehicular micro cloud leader 104 or the remote server 456 and stores, carries and performs the given tasks and completes its contribution remotely, for example when connected to a charging station. The EV 102 then informs the vehicular micro cloud leader 104 (which may no longer be a vehicular micro cloud leader 104 on account of the dissolution of the VMC 100 that it led), and/or the remote server 456. As such, the current method 500 facilitates the inclusion of EVs 102, such as BEVs and PHEVs, into a VMC 100, while reducing the effect the energy-consuming tasks have on EV 102 battery life to an extent that it may negatively impact the consumer experience.

FIGS. 6A-6E illustrate the operations of the VMC management system 234 in scheduling tasks for an EV 102 in the VMC 100. As depicted in FIG. 6, a VMC 100 is formed, either by the vehicular micro cloud leader 104 or a remote server 456. That is vehicles (e.g., the EV 102, vehicular micro cloud leader 104, and other vehicles 106-1, 106-2, 106-3, and 106-4) are grouped together based on their geographic position so as to collaborative complete tasks by sharing vehicle resources.

As depicted in FIG. 6B, the schedule module 348 may predict an energy discharge value associated with a planned task and an expected SOC status following completion of the task. For example, as depicted in FIG. 6C, the EV 102 battery may have a current battery level 658 and a predicted battery level 660 upon reaching an intended destination. As described above, the EV 102, the vehicular micro cloud leader 104, or the remote server 456 may determine a predicted SOC level 662 at an intended destination, should the EV 102 perform a VMC task while in the geographic region that defines the VMC 100.

FIG. 6D depicts an example where the VMC management system 234 is within the vehicular micro cloud leader 104 vehicle. As described above, whether the task is completed while the EV 102 is in the geographic region that defines the VMC 100 or subsequently, the vehicular micro cloud leader 104 may transmit information 664 to the EV 102 that allows the EV 102 to perform its assigned task.

As depicted in FIG. 6E, when the EV 102 SOC is greater than a threshold amount (e.g., when connected to a charging station 666), the EV 102 may perform the assigned task to complete its contribution to the VMC 100 and send its report/output to the remote server 456, which remote server 456 may process the results or transmit such to the vehicular micro cloud leader 104, which may no longer be leading a VMC 100. As such, the VMC management system 234 facilitates the inclusion of EVs 102, such as BEVs and PHEVs into a VMC 100, while reducing the negative impact energy-consuming tasks may have on EV 102 battery life.

FIG. 2 will now be discussed in full detail as an example environment within which the system and methods disclosed herein may operate. In some instances, the vehicle 208 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 208 as manipulated by a user (e.g., human driver). In one or more arrangements, the vehicle 208 can be a manually-controlled vehicle that is configured to operate in only the manual mode.

In one or more arrangements, the vehicle 208 implements some level of automation in order to operate autonomously or semi-autonomously. As used herein, automated control of the vehicle 208 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 208 along a travel route via a computing system to control the vehicle 208 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 208.

With continued reference to the various components illustrated in FIG. 2, the vehicle 208 includes one or more processors 209. In one or more arrangements, the processor(s) 209 can be a primary/centralized processor of the vehicle 208 or may be representative of many distributed processing units. For instance, the processor(s) 209 can be an electronic control unit (ECU). Alternatively, or additionally, the processors include a central processing unit (CPU), a graphics processing unit (GPU), an ASIC, a microcontroller, a system on a chip (SoC), and/or other electronic processing units that support operation of the vehicle 208.

The vehicle 208 can include one or more data stores 210 for storing one or more types of data. The data store 210 can be comprised of volatile and/or non-volatile memory. Examples of memory that may form the data store 210 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 210 is a component of the processor(s) 209. In general, the data store 210 is operatively connected to the processor(s) 209 for use thereby. The term “operatively connected,” as used throughout this description, can include direct or indirect connections, including connections without direct physical contact.

In one or more arrangements, the one or more data stores 210 include various data elements to support functions of the vehicle 208, such as semi-autonomous and/or autonomous functions. Thus, the data store 210 may store map data 211 and/or sensor data 212. The map data 211 includes, in at least one approach, maps of one or more geographic areas. In some instances, the map data 211 can include information about roads (e.g., lane and/or road maps), traffic control devices, road markings, structures, features, and/or landmarks in the one or more geographic areas. The map data 211 may be characterized, in at least one approach, as a high-definition (HD) map that provides information for autonomous and/or semi-autonomous functions.

In one or more arrangements, the map data 211 can include one or more terrain maps 213. The terrain map(s) 213 can include information about the ground, terrain, roads, surfaces, and/or other features of one or more geographic areas. The terrain map(s) 213 can include elevation data in the one or more geographic areas. In one or more arrangements, the map data 211 includes one or more static obstacle maps 214. The static obstacle map(s) 214 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 212 is data provided from one or more sensors of the sensor system 215. Thus, the sensor data 212 may include observations of the surrounding environment of the vehicle 208 and/or information about the vehicle 208 itself. In some instances, one or more data stores 210 located onboard the vehicle 208 store at least a portion of the map data 211 and/or the sensor data 212. Alternatively, or in addition, at least a portion of the map data 211 and/or the sensor data 212 can be located in one or more data stores 210 that are located remotely from the vehicle 208.

As noted above, the vehicle 208 can include the sensor system 215. The sensor system 215 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 215 and/or the one or more sensors can be operatively connected to the processor(s) 209, the data store(s) 210, and/or another element of the vehicle 208.

Various examples of different types of sensors will be described herein. However, it will be understood that the embodiments are not limited to the particular sensors described. In various configurations, the sensor system 215 includes one or more vehicle sensors 216 and/or one or more environment sensors. The vehicle sensor(s) 216 function to sense information about the vehicle 208 itself. In one or more arrangements, the vehicle sensor(s) 216 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 208.

As noted, the sensor system 215 can include one or more environment sensors 217 that sense a surrounding environment (e.g., external) of the vehicle 208 and/or, in at least one arrangement, an environment of a passenger cabin of the vehicle 208. For example, the one or more environment sensors 217 sense objects the surrounding environment of the vehicle 208. Such obstacles may be stationary objects and/or dynamic objects. Various examples of sensors of the sensor system 215 will be described herein. The example sensors may be part of the one or more environment sensors 217 and/or the one or more vehicle sensors 216. However, it will be understood that the embodiments are not limited to the particular sensors described. As an example, in one or more arrangements, the sensor system 215 includes one or more radar sensors 218, one or more LIDAR sensors 219, one or more sonar sensors 220 (e.g., ultrasonic sensors), and/or one or more cameras 221 (e.g., monocular, stereoscopic, RGB, infrared, etc.).

Continuing with the discussion of elements from FIG. 2, the vehicle 208 can include an input system 222. The input system 222 generally encompasses one or more devices that enable the acquisition of information by a machine from an outside source, such as an operator. The input system 222 can receive an input from a vehicle passenger (e.g., a driver/operator and/or a passenger). Additionally, in at least one configuration, the vehicle 208 includes an output system 223. The output system 223 includes, for example, one or more devices that enable information/data to be provided to external targets (e.g., a person, a vehicle passenger, another vehicle, another electronic device, etc.).

Furthermore, the vehicle 208 includes, in various arrangements, one or more vehicle systems 224. Various examples of the one or more vehicle systems 224 are shown in FIG. 2. However, the vehicle 208 can include a different arrangement of vehicle systems. It should be appreciated that although particular vehicle systems are separately defined, each or any of the systems or portions thereof may be otherwise combined or segregated via hardware and/or software within the vehicle 208. As illustrated, the vehicle 208 includes a propulsion system 225, a braking system 226, a steering system 227, a throttle system 228, a transmission system 229, a signaling system 230, and a navigation system 231.

The navigation system 231 can include one or more devices, applications, and/or combinations thereof to determine the geographic location of the vehicle 208 and/or to determine a travel route for the vehicle 208. The navigation system 231 can include one or more mapping applications to determine a travel route for the vehicle 208 according to, for example, the map data 211. The navigation system 231 may include or at least provide connection to a global positioning system, a local positioning system or a geolocation system.

In one or more configurations, the vehicle systems 224 function cooperatively with other components of the vehicle 208. For example, the processor(s) 209, the VMC management system 234, and/or automated driving module(s) 233 can be operatively connected to communicate with the various vehicle systems 226 and/or individual components thereof. For example, the processor(s) 209 and/or the automated driving module(s) 233 can be in communication to send and/or receive information from the various vehicle systems 226 to control the navigation and/or maneuvering of the vehicle 208. The processor(s) 209, the VMC management system 234, and/or the automated driving module(s) 233 may control some or all of these vehicle systems 226.

For example, when operating in the autonomous mode, the processor(s) 209, the VMC management system 234, and/or the automated driving module(s) 233 control the heading and speed of the vehicle 208. The processor(s) 209, the VMC management system 234, and/or the automated driving module(s) 233 cause the vehicle 208 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 208 includes one or more actuators 232 in at least one configuration. The actuators 232 are, for example, elements operable to move and/or control a mechanism, such as one or more of the vehicle systems 226 or components thereof responsive to electronic signals or other inputs from the processor(s) 209 and/or the automated driving module(s) 233. The one or more actuators 232 may include motors, pneumatic actuators, hydraulic pistons, relays, solenoids, piezoelectric actuators, and/or another form of actuator that generates the desired control.

As described previously, the vehicle 208 can include one or more modules, at least some of which are described herein. In at least one arrangement, the modules are implemented as non-transitory computer-readable instructions that, when executed by the processor 209, implement one or more of the various functions described herein. In various arrangements, one or more of the modules are a component of the processor(s) 209, or one or more of the modules are executed on and/or distributed among other processing systems to which the processor(s) 209 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 208 may include one or more automated driving modules 233. The automated driving module(s) 233, in at least one approach, receive data from the sensor system 215 and/or other systems associated with the vehicle 208. In one or more arrangements, the automated driving module(s) 233 use such data to perceive a surrounding environment of the vehicle. The automated driving module(s) 233 determine a position of the vehicle 208 in the surrounding environment and map aspects of the surrounding environment. For example, the automated driving module(s) 233 determines the location of obstacles or other environmental features including traffic signs, trees, shrubs, neighboring vehicles, pedestrians, etc.

The automated driving module(s) 233 either independently or in combination with the VMC management system 234 can be configured to determine travel path(s), current autonomous driving maneuvers for the vehicle 208, future autonomous driving maneuvers and/or modifications to current autonomous driving maneuvers based on data acquired by the sensor system 215 and/or another source. In general, the automated driving module(s) 233 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6E, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor;
a memory storing machine-readable instructions that, when executed by the processor, cause the processor to:
form a vehicular micro cloud (VMC) that comprises a group of interconnected vehicles that share resources to complete tasks, the group comprises an electric vehicle (EV);
schedule a time when the EV is to complete a planned task of the VMC based on a state of charge (SOC) of a battery of the EV; and
provide data associated with the planned task to the EV.

2. The system of claim 1, wherein the machine-readable instruction that causes the processor to schedule the time when the EV is to complete the planned task comprises a machine-readable instruction that, when executed by the processor, causes the processor to instruct the EV to immediately complete the planned task based on at least one of:
the SOC being greater than an SOC threshold amount;
a change to the SOC being less than a change threshold amount; or
the SOC allowing the EV to reach an intended destination.

3. The system of claim 1, wherein:
the machine-readable instruction that causes the processor to schedule the time when the EV is to complete the planned task comprises a machine-readable instruction that, when executed by the processor, causes the processor to, when the SOC is below a threshold amount, instruct the EV to complete the planned task at a future time when the SOC is greater than the threshold amount; and
the machine-readable instructions further comprise a machine-readable instruction that, when executed by the processor, causes the processor to receive data associated with a subsequently completed task from the EV.

4. The system of claim 3, wherein:
the machine-readable instructions further comprise a machine-readable instruction that, when executed by the processor, causes the processor to identify a remotely-completable planned task for the VMC that is completable at a later point in time; and
the machine-readable instruction that causes the processor to provide data associated with the planned task to the EV comprises a machine-readable instruction that causes the processor to provide data associated with the remotely-completable planned task to the EV.

5. The system of claim 1, wherein:
the machine-readable instructions further comprise a machine-readable instruction that, when executed by the processor, causes the processor to estimate an energy discharge value for the planned task;
the machine-readable instruction that causes the processor to schedule the time for the EV to complete the planned task comprises machine-readable instructions that cause the processor to:
schedule the time based on the SOC and an estimated energy discharge value for the planned task; and
when the estimated energy discharge value for the planned task reduces the SOC by a threshold discharge amount or reduces the SOC to below a threshold SOC value, instruct the EV to complete the planned task at a future time when the SOC is greater than the threshold SOC value.

6. The system of claim 5, wherein the machine-readable instruction that causes the processor to estimate the energy discharge value for the planned task comprises at least one of:
a machine-readable instruction that, when executed by the processor, causes the processor to estimate the energy discharge value based on a lookup table that maps energy discharge values to VMC tasks; or
a machine-readable instruction that, when executed by the processor, causes the processor to execute a machine-learning estimate of the energy discharge value.

7. The system of claim 5, wherein:
the machine-readable instructions further comprise a machine-readable instruction that, when executed by the processor, causes the processor to identify a destination of the EV;
the machine-readable instruction that causes the processor to schedule the time for the EV to complete the planned task comprises machine-readable instructions that cause the processor to:
schedule the time based on the SOC, the estimated energy discharge value for the planned task, and the destination of the EV; and
instruct the EV to complete the planned task at a future time when the SOC is greater than the threshold SOC value when the estimated energy discharge value for the planned task:
results in an estimated destination SOC from an original destination SOC greater than a threshold deviation amount; or
renders the EV unable to reach the destination.

8. The systems of claim 1, wherein the machine-readable instructions further comprise a machine-readable instruction that, when executed by the processor, causes the processor to provide an output of the VMC to the EV independent of the time when the EV completes the planned task.

9. A non-transitory machine-readable medium comprising instructions that, when executed by a processor, cause the processor to:
form a vehicular micro cloud (VMC) that comprises a group of interconnected vehicles that share resources to complete tasks, the group comprises an electric vehicle (EV);
schedule a time when the EV is to complete a planned task of the VMC based on a state of charge (SOC) of a battery of the EV; and
provide data associated with the planned task to the EV.

10. The non-transitory machine-readable medium of claim 9, wherein:
the instruction that causes the processor to schedule the time when the EV is to complete the planned task comprises an instruction that, when executed by the processor, causes the processor to, when the SOC is below a threshold amount, instruct the EV to complete the planned task at a future time when the SOC is greater than the threshold amount; and
the instructions further comprise an instruction that, when executed by the processor, causes the processor to receive data associated with a subsequently completed task from the EV.

11. The non-transitory machine-readable medium of claim 10, wherein:
the instructions further comprise an instruction that, when executed by the processor, causes the processor to identify a remotely-completable planned task for the VMC that is completable at a later point in time; and
the instruction that causes the processor to provide data associated with the planned task to the EV comprises an instruction that causes the processor to provide data associated with the remotely-completable planned task to the EV.

12. The non-transitory machine-readable medium of claim 9, wherein:
the instructions further comprise an instruction that, when executed by the processor, causes the processor to estimate an energy discharge value for the planned task;
the instruction that causes the processor to schedule the time for the EV to complete the planned task comprises instructions that cause the processor to:
schedule the time based on the SOC and an estimated energy discharge value for the planned task; and
when the estimated energy discharge value for the planned task reduces the SOC by a threshold discharge amount or reduces the SOC to below a threshold SOC value, instruct the EV to complete the planned task at a future time when the SOC is greater than the threshold SOC value.

13. The non-transitory machine-readable medium of claim 12, wherein the instruction that causes the processor to estimate the energy discharge value for the planned task comprises at least one of:
an instruction that, when executed by the processor, causes the processor to estimate the energy discharge value based on a lookup table that maps energy discharge values to VMC tasks; or
an instruction that, when executed by the processor, causes the processor to execute a machine-learning estimate of the energy discharge value.

14. The non-transitory machine-readable medium of claim 12, wherein:
the instructions further comprise an instruction that, when executed by the processor, causes the processor to identify a destination of the EV;
the instruction that causes the processor to schedule the time for the EV to complete the planned task comprises instructions that cause the processor to:
schedule the time based on the SOC, the estimated energy discharge value for the planned task, and the destination of the EV; and
instruct the EV to complete the planned task at a future time when the SOC is greater than the threshold SOC value when the estimated energy discharge value for the planned task:
results in an estimated destination SOC from an original destination SOC greater than a threshold deviation amount; or
renders the EV unable to reach the destination.

15. A method, comprising:
forming a vehicular micro cloud (VMC) that comprises a group of interconnected vehicles that share resources to complete tasks, the group comprises an electric vehicle (EV);
scheduling a time when the EV is to complete a planned task of the VMC based on a state of charge (SOC) of a battery of the EV; and
providing data associated with the planned task to the EV.

16. The method of claim 15, wherein:
scheduling the time when the EV is to complete the planned task comprises, when the SOC is below a threshold amount, instructing the EV to complete the planned task at a future time when the SOC is greater than the threshold amount; and
the method further comprises receiving data associated with a subsequently completed task from the EV.

17. The method of claim 16, wherein:
The method further comprises identifying a remotely-completable planned task for the VMC that is completable at a later point in time; and
providing data associated with the planned task to the EV comprises providing data associated with the remotely-completable planned task to the EV.

18. The method of claim 15, wherein:
the method further comprises estimating an energy discharge value for the planned task;
scheduling the time for the EV to complete the planned task comprises:
scheduling the time based on the SOC and an estimated energy discharge value for the planned task; and
when the estimated energy discharge value for the planned task reduces the SOC by a threshold discharge amount or reduces the SOC to below a threshold SOC value, instruct the EV to complete the planned task at a future time when the SOC is greater than the threshold SOC value.

19. The method of claim 18, wherein estimating the energy discharge value for the planned task comprises at least one of:
estimating the energy discharge value based on a lookup table that maps energy discharge values to VMC tasks; or
executing a machine-learning estimate of the energy discharge value.

20. The method of claim 18, wherein:
the method further comprises identifying a destination of the EV;
scheduling the time for the EV to complete the planned task comprises:
scheduling the time based on the SOC, the estimated energy discharge value for the planned task, and the destination of the EV; and
instructing the EV to complete the planned task at a future time when the SOC is greater than the threshold SOC value when the estimated energy discharge value for the planned task:
results in an estimated destination SOC from an original destination SOC greater than a threshold deviation amount; or
renders the EV unable to reach the destination.
